(19) United States
(12) Patent Application Publication
(10) Pub. No.: US 2024/0290026 A1
(43) Pub. Date: Aug. 29, 2024

(54) METHOD AND APPARATUS FOR CONTROLLING MOTION OF MOVING OBJECT, DEVICE, AND STORAGE MEDIUM

(71) Applicant: Beijing Zitiao Network Technology Co., Ltd., Beijing (CN)

(72) Inventor: Yixin CHEN, Beijing (CN)

(21) Appl. No.: 18/572,661

(22) PCT Filed: Aug. 23, 2022
(86) PCT No.: PCT/CN2022/114202

§ 371 Date: Dec. 20, 2023

(30) Foreign Application Priority Data
Sep. 6, 2021 (CN) 202111040348.X

(51) Int. Cl. G06T 13/80; G06T 7/246; G06V 10/56

(52) U.S. Cl. CPC G06T 13/80; G06T 7/246; G06V 10/56

(57) ABSTRACT

A method for controlling a moving object to move, an apparatus, a device, a computer-readable storage medium, and a computer program product are provided. The method includes: obtaining first motion state information, wherein the first motion state information is motion state information of a user; updating second motion state information of the moving object according to the first motion state information; and controlling the moving object to move according to the second motion state information.

The present application claims priority of Chinese Patent Application No. 202111040348.X, titled “METHOD AND APPARATUS FOR CONTROLLING MOTION OF MOVING OBJECT, DEVICE, AND MEDIUM” and filed with State Intellectual Property Office of China on Sep. 6, 2021, the entire disclosure of which is incorporated by reference as part of the disclosure of the present application.

### TECHNICAL FIELD

The present disclosure relates to the technical field of computers, and in particular, to a method and apparatus for controlling motion of a moving object, an apparatus, a device, a computer-readable storage medium, and a computer program product.

### BACKGROUND

With the continuous development of the computer technology, many applications (APPs) have emerged. To improve the interaction performance, moving objects are set in many APPs so that users can control the moving objects to move. The moving object refers to a movable virtual object. For example, a car race game APP provides various cars (virtual cars), and a user may interact with a computer to control a car to move.

At present, a plurality of solutions for controlling motion of a moving object are provided in the industry. For example, a user may control a moving object (e.g., a racing car) to move according to a set direction by using a key of a mouse or moving the mouse on the desktop. For another example, a user may control a moving object to move according to a set direction by controlling a joystick to move in a leftward, rightward, frontward, and backward directions.

The control manner requires extra configuration of hardware, and is relatively complicated in operation, affecting user experience.

### SUMMARY

An objective of the present disclosure is to provide a method and apparatus for controlling motion of a moving object, a device, a computer-readable storage medium, and a computer program product that can simplify a control operation of a user, enhance the user's use experience, and reduce the control cost.

On the first aspect, the present disclosure provides a method for controlling motion of a moving object, comprising: obtaining first motion state information, wherein the first motion state information is motion state information of a user; updating second motion state information of the moving object according to the first motion state information; and controlling the moving object to move according to the second motion state information.

On the second aspect, the present disclosure provides an apparatus for controlling motion of a moving object, comprising: a communication module configured to obtain first motion state information, wherein the first motion state information is motion state information of a user; an updating module configured to update second motion state information of the moving object according to the first motion state information; and a control module configured to control the moving object to move according to the second motion state information.

On the third aspect, the present disclosure provides an electronic device, comprising: a storage device in which a computer program is stored; and a processing device configured to execute the computer program in the storage device to implement the method provided by the present disclosure on the first aspect or the second aspect.

On the fourth aspect, the present disclosure provides a computer-readable storage medium in which a computer program is stored, and the method provided by the present disclosure on the first aspect or the second aspect is implemented when the computer program is executed by a processing unit.

On the fifth aspect, the present disclosure provides a computer program product, and when the computer program product is run on a computer, the computer is enabled to implement the method by the present disclosure on the first aspect or the second aspect.

In view of above, the technical solutions provided by the present disclosure have following advantages: through the above technical solutions, the motion state information of the user, namely the first motion state information, can be obtained by a terminal, and then the motion state information of a moving object, namely the second motion state information, can be updated according to the first motion state information, and then the moving object can be controlled to move according to the second motion state information. Thus, the moving object may be controlled to move according to the motion state information of the user. The control operation is simplified and the user experience is improved. Moreover, the control method does not require addition of extra hardware, such as a joystick, and the control cost is reduced

Other features and advantages of the present disclosure will be described in detail in the following detailed description.

### BRIEF DESCRIPTION OF THE DRAWINGS

To explain the technical methods in the embodiments of the present disclosure more clearly, the accompanying drawings required in the embodiments will be described below in brief.

FIG. 1 is a flowchart of a method for controlling motion of a moving object provided in an embodiment of the present disclosure;

FIG. 2 is a diagram of a user interface for a plurality of users to control motion of a moving object provided in an embodiment of the present disclosure;

FIG. 3 is a user interface for a selecting user to control motion of a moving object provided in an embodiment of the present disclosure;

FIG. 4 is a schematic diagram of a projection matrix provided in an embodiment of the present disclosure;

FIG. 5 is a schematic diagram of rotation of Euler angles provided in an embodiment of the present disclosure;

FIG. 6 is a diagram of an interface of another method for controlling motion of a moving object provided in an embodiment of the present disclosure;

FIG. 7 is a diagram of an interface of further another method for controlling motion of a moving object provided in an embodiment of the present disclosure;

FIG. 8 is a schematic diagram of an apparatus for controlling motion of a moving object provided in an embodiment of the present disclosure; and

FIG. 9 is a structural schematic diagram of an electronic device provided in an embodiment of the present disclosure.

### DETAILED DESCRIPTION

The terms such as “first” and “second” in the embodiments of the present disclosure are used only for the purpose of description and should not be construed as indicating or implying relative importance, or implicitly indicating the number of technical features indicated. Thus, features defined with “first” and “second” may explicitly or implicitly include one or more of the features.

In display interfaces of some APPs, the human-machine interaction technology may be used to improve the interestingness of a user using the APPs. For example, a moving direction of a moving object may be controlled by the human-machine interaction technology. Specifically, a user may control a moving object to move by means of a mouse or the “up”, “down”, “leftward”, and “leftward” keys in a keyboard, and may also manipulate motion of the moving object by moving a joystick.

However, the above control manner for the moving object requires extract configuration of hardware, e.g., addition of an external keyboard or addition of a joystick, and the whole operation process is complicated and affects a user's use experience. On this basis, there is an urgent need for a method for controlling a moving object to move in the industry to simplify accessories needed by a user to control the moving object, simplify the operations of the user, and enhance the use experience of the user.

In view of this, an embodiment of the present disclosure provides a method for controlling motion of a moving object. The method may be applied to a processing device that may be a server or a terminal. The terminal includes but is not limited to a smart phone, a Pad, a laptop, a personal digital assistant (PDA), an intelligent home device, or an intelligent wearable device. The server may be a cloud server, e.g., a central server in a central cloud computing cluster or an edge server in an edge cloud computing cluster. As a matter of course, the server may also be a server in a local data center. The local data center refers to a data center directly controlled by a user.

Specifically, the processing device obtains motion state information of a user, namely first motion state information, motion state information of a moving object, namely second motion state information, according to the first motion state information, and then controls the moving object to move according to the second motion state information. Thus, the moving object may be controlled to move according to the motion state information of the user. The control operation is simplified and the user experience is improved. Moreover, the control method does not require addition of extra hardware, such as a joystick, and the control cost is reduced.

To make the technical solution of the present disclosure clearer and comprehensible, the method for controlling motion of a moving object provided in the embodiments of the present disclosure is described below from the perspective of a terminal.

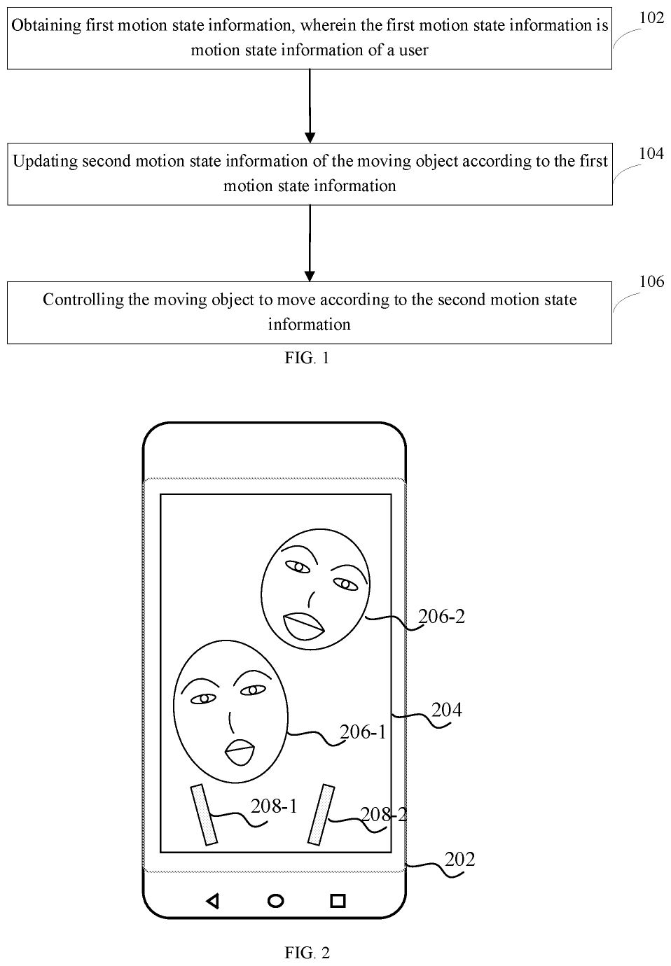

FIG. 1 is a flowchart of a method for controlling motion of a moving object provided in an embodiment of the present disclosure. The method may be applied to a terminal and includes the following steps.

S102: obtaining first motion state information by the terminal.

The first motion state information may be the motion state information of a user. The motion state information of the user may be motion information of the user's body, or may be motion information of a certain part of the user's body. For example, the motion state information of the user may be one or more of a pitch angle, a yaw angle, and a roll angle of the head of the user. Specifically, the head of the user may perform a plurality of kinds of motion such as nodding and shaking, and the terminal obtains an image of the head of the user by means of a camera to obtain the motion state information of the user. The camera may be a camera for photographing the head of the user. When the terminal is a mobile phone, the camera may be a front-facing camera or a rear camera of the mobile phone.

In some possible implementations, the terminal may obtain a head image of the user at a current time by invoking the camera. The head image of the user at the current moment may be referred to as a current frame. It needs to be noted that the current frame captured by the terminal is a front-facing head image which may refer to a head image from which a human face can be seen. The terminal may perform human face identification on the current frame to obtain position information of a key point. The key point refers to a point having special meaning in the human face region. For example, the key point may be any one or more of eyebrows, eyes, nose, and mouth. The terminal may then obtain the first motion state information by matrix transformation according to the position information of the key point and position information of a camera for photographing the user.

Specifically, the position information of the key point may include the coordinate of the key point. The position information of the camera may include a pose of the camera. A model-view-projection (MVP) matrix may be determined based on the pose of the camera. The MVP matrix is configured to convert two-dimensional information into three-dimensional information. Specifically, an inverse matrix of the MVP matrix may transform a coordinate in a clip space into a coordinate in a model space. The terminal may map the position information of the key point in the current frame to a three-dimensional space through the MVP matrix to obtain a first point set in the three-dimensional space. The terminal may further obtain a standard tiled human face key point array and map the array to the three-dimensional space through the MVP matrix to obtain a second point set in the three-dimensional space. The terminal may then determine a rotation vector according to the first point set and the second point set in the three-dimensional space. In practical use, the terminal may calculate the rotation vector with the position information of the key point, the standard tiled human face key point array, and the MVP matrix as parameters by using a solvePnP algorithm.

Further, the terminal may transform the rotation vector into a rotation matrix, e.g., by the following formula:

$$R = cos θ I + ( 1 - cos θ ) {nn}^{T} + sin cos θ n \hat{} \qquad ( 1 )$$

where β represents the rotation matrix; I represents a unit matrix; n represents a unit vector of the rotation vector; and θ represents a modulus length of the rotation vector.

The terminal may further transform the rotation matrix β into Euler angles to obtain rotation angles of three axes. The three axes may be pitch, yaw, and roll. The obtained angles of the three axes may be used as the first motion state information.

Correspondence transformation between the rotation matrix and Euler angles is described below. As shown in FIG. 5, a represents a yaw angle, namely an angle of rotation around the Z-axis; β represents a pitch angle, namely an angle of rotation around the Y-axis; and γ represents a roll angle, namely an angle of rotation around the X-axis.

When the rotation matrix

$$R = [ \begin{matrix}r 11 & r 12 & r 13 \\ r 21 & r 22 & r 23 \\ r 31 & r 32 & r 33\end{matrix} ] ,$$

the yaw angle, the pitch angle, and the roll angle may be correspondingly obtained according to the rotation matrix.

$$α = arc tan 2 ( r 21 , r 11 ) \qquad ( 2 )$$

$$β = arc tan 2 ( - r 31 , \sqrt{( r {32}^{2} + r {33}^{2} )} ) \qquad ( 3 )$$

$$γ = arc tan 2 ( r 32 , r 33 ) \qquad ( 4 )$$

The yaw angle, the pitch angle, and the roll angle corresponding to the rotation matrix β may be obtained by formula (2), formula (3), and formula (4), where r21, r11, r31, r32, and r33 in formula (2), formula (3), and formula (4) are the same as r21, r11, r31, r32, and r33 in the rotation matrix R.

Taking an airplane for example, the angles (the pitch angle, the yaw angle, and the roll angle) of the three axes are described below. In an airframe coordinate system, the origin 0 is at the center of mass of the airplane; the positive direction of the X-axis is within the symmetry plane of the airplane and points to the nose of the airplane in parallel to the design axis of the airplane; the positive direction of the Y-axis is perpendicular to the symmetry plane of the airplane and points to the right side of the airplane; and the positive direction of the Z-axis is within the symmetry plane of the airplane, is perpendicular to the X-axis and points to the lower side of the airframe. The yaw angle refers to an angle of rotation around the Z-axis; the pitch angle refers to an angle of rotation around the Y-axis; and the roll angle refers to an angle of rotation around the X-axis. The image of the head of the user captured by the terminal by means of the camera may be continuous video frames. The terminal may select any one frame from the continuous video frames for human face identification. The terminal may also select a plurality of frames from the continuous video frames for human face identification, thereby obtaining the position information of a face key point of the user.

The position information of the face key point of the user may be used to determine a user when a plurality of users are present in frames captured by the camera. In some scenarios, a plurality of users may be present in the image of the head of the user captured by the camera, and whether the user is determined as a target user may be determined by identifying the position information of the face key point of the user. For example, when there are a plurality of users having clear face key point information in the frame captured, the plurality of users may be all determined as target users, or a preset number of target users may be selected from the plurality of users. Likewise, it may also be a case where no key point information is collected from the frame. For example, it may be a case a too long distance or overexposure of the face, leading to a failure to identify the face key point. Therefore, the terminal may select another user as the target user. The following description is made by taking for example that there are two users having clear face key point information in the captured frame 206.

When there are two users both having clear face key point information in the captured frame, the two users are both set as the target users, and the respective motion state information of the heads of the two users is obtained. Correspondingly, a corresponding number of moving objects may be generated according to the identified number of users in the frame, and positions of the moving objects may be determined according to positions of the users. As shown in FIG. 2, the display interface 204 of the terminal includes display frames 206-1 and 206-2 corresponding to two users, and correspondingly, there are two moving objects 208-1 and 208-2. The moving object 208 moves by following the motion state of the head of the user.

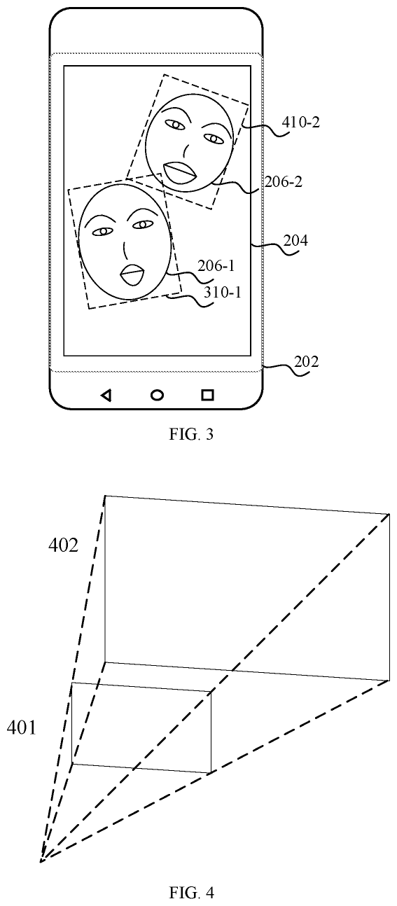

When there are two users both having clear face key point information in the captured frame, one user may be selected therefrom as the target user. For example, the terminal may determine the positions of the users according to the face key points of the users, and determine the one of the two users who is located in the middle of the frame as the target user. The terminal may also select the two users using boxes in the screen. As shown in FIG. 3, the display frame of a user is selected using a prompt box 310. The display frame 206-1 is selected using the prompt box 310-1 and the display frame 206-2 is selected using the prompt box 310-2. A user is prompted to select from the two selected users, and the target user is determined in response to the selection of the user.

The position information of the face key point of the user may be used to determine the motion state of the head of the user. Different users have different face key points. According to a motion trajectory of the face key point of a user, the corresponding motion state information of the head of the user may be determined.

When determining the corresponding motion state information of the head of the user according to the motion trajectory of the face key point of the user, since the motion trajectory of the face key point of the user collected by the terminal through the camera is a two-dimensional motion trajectory, a relation needs to be established between the motion trajectory of the key point and the motion state information of the three-dimensional head of the user.

In some possible implementations, the terminal may obtain the motion state information of the three-dimensional head of a user under the coordinate system of a model space by an inverse matrix of a model-view-projection (MVP) matrix according to the collected face key point of the user and camera parameters of the terminal. The MVP matrix may be a matrix obtained by matrix multiplication of a model (M) matrix, a view (V) matrix, and a projection (P) matrix. The model matrix, the view matrix, and the projection matrix are described below, respectively.

The model matrix is configured to transform the coordinates of an object in the model space to coordinates in a world space. The model matrix uses a left-half coordinate system and obtains the coordinates of an object in the world space by scaling, rotating, and translating the coordinates of the object in the model space.

The view matrix is configured to transform the coordinates of an object in the world space to coordinates in a view space. The view space refers to a coordinate system with the camera as the center, also referred to a camera space. The view matrix may cause the origin of the camera to be the origin of the coordinate system in the world space by obtaining the position of the camera and translating the whole view space. The coordinate axes of the camera space coincide with the coordinate axes of the world space. Since the world space is the left-half coordinate system and the camera space is a right-half coordinate system, the calculated Z-axis component in the transformation matrix needs to be inverted. Thus, the view matrix can be obtained.

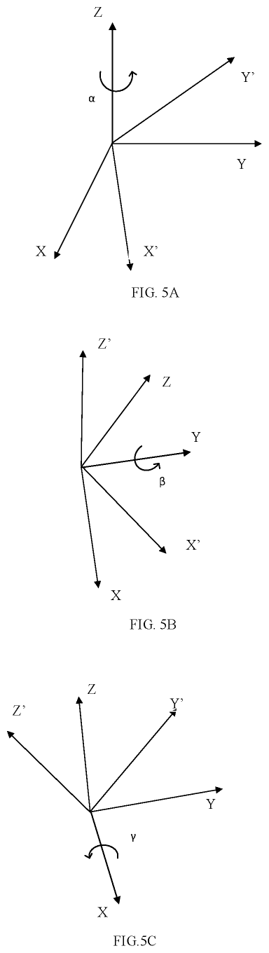

The projection matrix is configured to project an object from the view space to a clip space to determine whether a vertex is visible. The clip space is used for determining which part of the object can be projected. Usually, the projection matrix includes orthogonal projection and perspective projection. Based on that an image looks small in the distance and big on the contrary, in perspective projection, a visual cone space is projected from the camera. A cone space may be clipped from the cone space by a near clip plane 401 and a far clip plane 402, and the cone space is a visible space of perspective projection, as shown in FIG. 4.

Correspondingly, the inverse matrix of the MVP matrix is configured to transform a two-dimensional coordinate in the clip space into a three-dimensional coordinate in the view space by an inverse matrix of the projection matrix, then transform the coordinate in the view space into a coordinate in the world space by an inverse matrix of the view matrix, and finally transform the coordinate in the world space into a coordinate in the model space by an inverse matrix of the model matrix. Thus, the motion state information of the three-dimensional head of the user in the model space can be obtained according to a face array of the user established with the collected face key points of the user and the camera parameters of the terminal.

In some possible implementations, a standard tiled human face key point array may be established, and then the motion state information of the three-dimensional head of the user in the coordinate system of the model space in combination with the face key point data of the user collected by the terminal and the camera parameters of the terminal. The standard tiled human face key point array is a universal human face key point data array when the face is in the middle of the screen and the face is clear. The array is used for comparison with the collected face key point data of the user to determine the motion condition of the head of the user. Specifically, the rotation vector of head motion of the user may be calculated using the solvePnP algorithm with the face key point data of the user collected by the terminal, the standard tiled human face key point array, and the inverse matrix of the MVP matrix. The MVP matrix includes the camera parameters of the terminal.

The rotation vector is capable of representing the motion state of the head of the user in the model space, which is consistent with the motion state of the head of the real user. Due to the limitation of the camera of the terminal, the terminal cannot directly obtain the actual motion state of the user and can only obtain the motion state of the actual motion state in the clip space. Therefore, the actual motion state of the user may be obtained according to the motion of the motion state of the user in the clip space and the position parameter of the camera of the terminal.

After the terminal obtains the rotation vector of the head of the user, the rotation vector may be transformed into the rotation matrix, and then the rotation matrix is transformed into Euler angles. The Euler angles may represent a change in the motion state of an object by describing changes of coordinate axes. The Euler angles may be used to describe the motion state information of the head of the user. Specifically, the Euler angles may describe the rotational motion state information of an object by the rotations of three axes. An angle of rotation around the Z-axis may be denoted by a, and an angle of rotation around the Y-axis as β and an angle of rotation around the X-axis as γ, as shown in FIG. 5. In FIG. 5, diagram A represents rotating a around the X-axis and the Y-axis; diagram A represents rotating β around the X-axis and the Z-axis; and diagram C represents rotating γ around the Y-axis and the Z-axis.

Specifically, after the transformation of the XYZ coordinate system, the new coordinate system may be obtained as follows:

$$\begin{matrix}{R}_{ZYX} = {R}_{Z} ( α ) {R}_{Y} ( β ) {R}_{x} ( γ ) \\ = [ \begin{matrix}cos α & - sin α & 0 \\ sin α & cos α & 0 \\ 0 & 0 & 1\end{matrix} ] [ \begin{matrix}cos β & 0 & sin β \\ 0 & 1 & 0 \\ - sin β & 0 & cos β\end{matrix} ] [ \begin{matrix}1 & 0 & 0 \\ 0 & cos γ & - sin γ \\ 0 & sin γ & cos γ\end{matrix} ]\end{matrix} \qquad ( 4 )$$

The following can be obtained by calculation:

$${R}_{ZYX} = \qquad ( 5 )$$

$$[ \begin{matrix}cos α cos β & cos α sin β sin γ - sin α cos γ & cos α sin β cos γ + sin α sin γ \\ sin α cos β & sin α sin β sin γ + cos α cos γ & sin α sin β cos γ - cos α sin γ \\ - sin β & cos β sin γ & cos β sin γ\end{matrix} ]$$

A motion angle of the head of the user may be obtained according to the rotation vector of the head of the user. Usually, the values of the Euler angles transformed from the rotation matrix are radian values. To more intuitively obtain the motion state of the head of the user, the radian values may be converted to angle values.

Since the camera of the terminal captures the motion information of the head of the user in units of frames, the time information of the head motion may be obtained for calculating an angle change per frame, thereby obtaining rotation angle changes of the head of the user in the directions of three axes per frame. A pitch angle change rate, a yaw angle change rate, and a roll angle change rate of the user may be obtained according to the rotation angle changes of the head of the user in the directions of three axes per frame. The change rate may characterize a rotation angle change per frame.

Thus, according to the two-dimensional image of the head of the user captured by the camera of the terminal, the motion state information of the head of the user in the model space can be obtained by coordinate transformation.

S104: updating the second motion state information of the moving object 208 according to the first motion state information.

The moving object 208 refers to an object having a default motion state itself. The default motion state includes translation and rotation. The terminal obtains the second motion state information of the moving object 208 by superposing the obtained first motion state information to the default motion state. The second motion state information at a previous time point is updated according to the obtained second motion state information.

In some possible implementations, the terminal may also invert the obtained first motion state information and superpose the inverted obtained first motion state information to the default motion state such that the motion state of the moving object is completely opposite to the motion state of the head of the user to present a display effect similar to a mirror image in the display interface 204.

The terminal may superpose the first motion state information to the default motion state by decomposition. Specifically, the first motion state, namely the motion state information of the head, is decomposed into rotation velocities on three axes to transfer to the moving object 208. The moving object 208 rotates according to the rotation velocities on the three axes on the basis of the default motion state. That is, the first motion state is superposed to a default moving velocity of the moving object 208 to obtain the second motion state information. That is, the pitch angle change rate, the yaw angle change rate, and the roll angle change rate of the user are transferred to the moving object to obtain the second motion state information of the moving object.

In some possible implementations, there may be a case where no head of the user is identified or the head of the user does not move. That is, the first motion state information may be 0. Therefore, the second motion state information of the moving object 208 is preset motion state information. The preset motion state information includes translation and rotation, and the second motion state information also includes translation and rotation.

Usually, velocities in the rotational motion information in the default motion state information of the moving object 208 and the motion state of the head of the user are large. For example, the rotation velocity of the moving object 208 in the default motion state information is far lower than the moving velocity of the head of the user. Therefore, there may be a case where the rotation in the default motion state information and the rotation in the first motion state information cancel each other out.

In some possible implementations, the rotation velocity in the default motion state information of the moving object 208 is usually low, and therefore, the display frame of the terminal may show that the moving object 208 correspondingly moves by following the motion state of the head of the user. As shown in FIG. 3, the following description is made by taking for example that the moving object 208 is a vertically placed coin. When the head of a user turns to the left, the coin turns to the left; and when the head of the user turns to the right, the coin turns to the right.

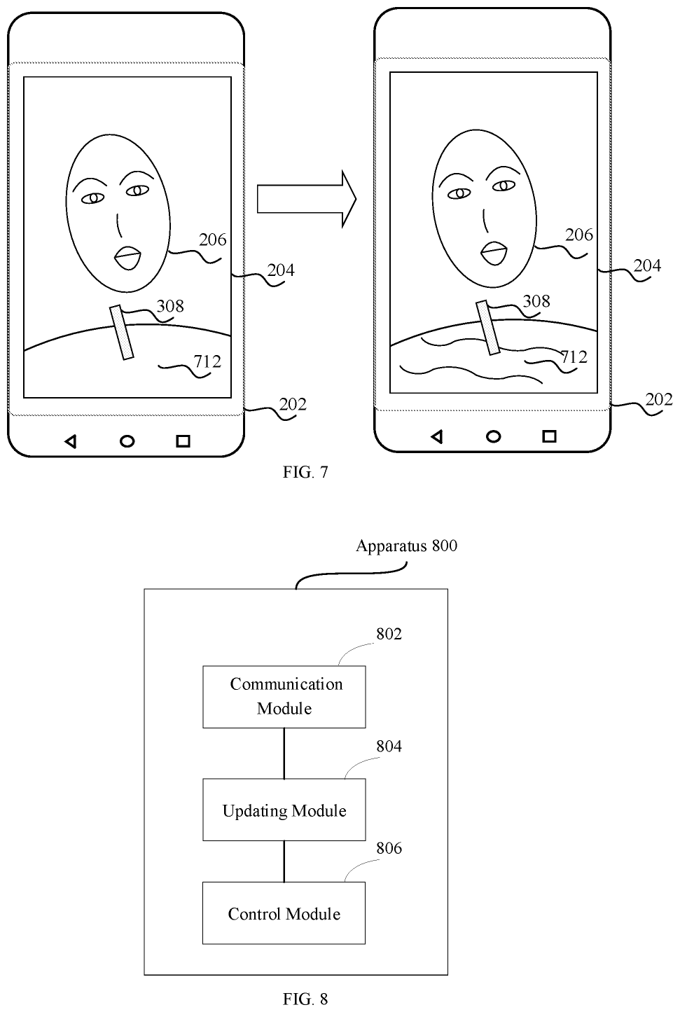

The moving object 208 in the present disclosure may be objects of various types, e.g., may be a small animal in the display frame or a certain part of the small animal. As shown in FIG. 7, the head 208 of a cat moves with the motion of the head of a user.

S106: controlling the moving object 208 to move according to the second motion state information by the terminal.

The second motion state information of the moving object 208 is obtained by superposing the default motion state information with the first motion state information and includes translation and rotation. The default motion state information includes translation and rotation, and the first motion state information also includes translation and rotation. Therefore, the second motion state information includes translation and rotation. Usually, the translation in the second motion state information is different from the translation in the default motion state information because both of a rotation amount and a translation amount are changed after the first motion state is superposed to the default motion state. However, there may be a case where the translation in the second motion state information is the same as the translation in the default motion state information; for example, the first motion state is 0.

The terminal may render the moving object 208 according to the second motion state information of the moving object 208 to show a frame of the moving object 208 moving according to the second motion state information in the display frame 204 of the terminal.

In some possible implementations, to reduce rendering of the frame and increase a frame loading speed, a visual effect similar to the translation of the moving object 208 may be produced by a relative motion relationship. For example, a plane may be added under the moving object 208, as shown in FIG. 8, and then the plane 712 under the moving object 208 is rendered. An original offset of the moving object 208 is transferred to the plane 712. Specifically, the second motion state information of the moving object is determined as a texture coordinate offset of each pixel in the plane, whereby the texture coordinate of each pixel in the plane is then updated. Thus, the motion effect of the plane where the moving object is located is rendered by a shader.

The terminal may decompose an offset in the second motion state information of the moving object 208 into moving velocity components in the two directions of the x-axis and the y-axis. Specifically, the terminal may decompose an orientation of the moving object 208 in the second motion state information into components in the two directions of the X-axis and the Y-axis and then multiply each of the components by a corresponding moving velocity to obtain the moving velocity components in the two directions of the X-axis and the Y-axis.

The terminal may achieve the motion effect of moving of the plane 712 where the moving object 208 is located by rendering using a shader according to the offset of the plane 712 where the moving object 208 is located. When the terminal renders the motion of the plane 712 where the moving object 208 is located by the shader, the shader usually has rendered the previous frame of the image of the plane 712. Therefore, an offset variation of the plane 712 in each frame may be obtained according to the moving velocity in the second motion state information. The offset variation is superposed to the offset of the previous frame to obtain the display effect of the plane 712 at the corresponding time point.

The offset of the plane 712 may be represented by the texture coordinate (UV coordinate). The UV coordinate may define the pixel information of any point. By the UV coordinate, each point of an image may accurately correspond to a point on the surface of a model object. A gap between points is filled in the form of a map. A pixel value of any point of an image may be obtained by the UV coordinate of the point. A color value of a pixel may be determined according to the texture coordinate of the pixel and a correspondence between the texture coordinate and the color in the map.

The terminal may obtain an offset of the texture coordinate of each pixel in the plane according to the moving velocity of the moving object 208 in the second motion state information and then update the texture coordinate of each pixel in the plane of the previous frame, thereby obtaining the texture coordinate of each pixel in the plane of the current frame. The UV coordinate of each pixel in the plane of any frame may be obtained by adding the UV coordinate of each pixel in the plane of the previous frame with a variation of the UV coordinate of the pixel. In some possible implementations, the terminal may obtain the texture coordinate of each pixel in a plane where the moving object is located and then normalize the texture coordinates to obtain the texture coordinates having a value in a range of 0 to 1. The terminal may normalize the texture coordinate value of each pixel by removing an integer part of the value and retaining a decimal part of the value. The terminal may also normalize the texture coordinate value of each pixel in the plane by reducing the value to a value between 0 and 1 according to a fixed ratio. The terminal may then determine the color value of each pixel in the plane according to the correspondence between the texture coordinate and the color in the map and the normalized texture coordinate. The map may be a predetermined plane image in a static state. Different texture coordinates may correspond to different color values. According to the determined color value of each pixel in the plane, a color of each pixel in the plane where the moving object is located is rendered by the shader, causing the plane to exhibit a motion effect. A change in color of the plane may represent the motion of the plane, thereby achieving the motion effect of the moving object moving relation to the plane. When the moving object moves relative to the plane, only the motion of the plane needs to be rendered, and rendering of a frame is reduced and the frame loading speed is increased, thus further enhancing the user experience.

Based on the description of the above contents, the embodiments of the present disclosure provide the method for controlling motion of the moving object 208. Specifically, the terminal obtains the motion state information of a user, then updates the motion state information (the second motion state information) of the moving object according to the motion state information of the user, and then controls the moving object to move according to the second motion state information. Thus, the moving object may be controlled to move according to the motion state information of the user. The control operation is simplified and the user experience is improved. Moreover, the control method does not require addition of extra hardware, and the control cost is reduced.

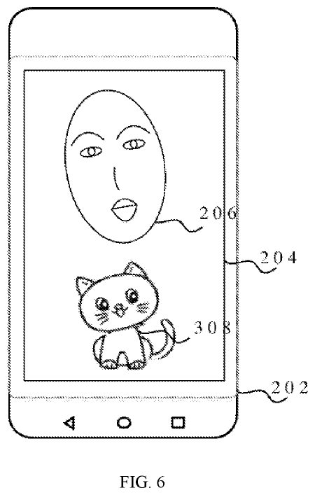

The method for controlling motion of a moving object provided in the embodiments of the present disclosure is described in detail above with reference to FIG. 1 to FIG. 7. An apparatus and a device provided in the embodiments of the present disclosure will be described below with reference to the accompanying drawings.

FIG. 8 is a schematic diagram of an apparatus for controlling motion of a moving object according to an exemplary embodiment of the present disclosure. As shown in FIG. 8, the apparatus 800 for controlling motion of a moving object includes: a communication module 802 configured to obtain first motion state information, where the first motion state information is motion state information of a user; an updating module 804 configured to update second motion state information of the moving object according to the first motion state information; and a control module 806 configured to control the moving object to move according to the second motion state information.

Alternatively, the control module 806 may be configured to: control a plane where the moving object is located to move according to the second motion state information of the moving object such that the moving object moves relative to the plane where the moving object is located.

Alternatively, the control module 806 may be configured to: determine a texture coordinate offset of each pixel in the plane where the moving object is located according to the second motion state information of the moving object; update texture coordinate of each pixel in the plane where the moving object is located according to the texture coordinate offset of each pixel in the plane where the moving object is located; and render a motion effect of the plane where the moving object is located by a shader according to the updated texture coordinate of each pixel in the plane where the moving object is located.

Alternatively, the control module 806 may be configured to: obtain a normalized value of the texture coordinate of each pixel in the plane where the moving object is located; determine a color value of each pixel in the plane where the moving object is located according to a correspondence between a texture and a color and the normalized value of the texture coordinate; and render a color of each pixel in the plane where the moving object is located by the shader according to the color value to render the motion effect of the plane where the moving object is located.

Alternatively, the first motion state information includes a pitch angle, a yaw angle, and a roll angle of the user; and the second motion state information includes a pitch angle, a yaw angle, a roll angle, and a moving velocity of the moving object.

Alternatively, the communication module 802 may be configured to: identify a key point of the user to obtain position information of the key point; and obtain the first motion state information by matrix transformation according to the position information of the key point and position information of a camera for photographing the user.

Alternatively, the communication module 802 may be configured to: construct a coordinate transformation matrix according to the position information of the camera, where the coordinate transformation matrix is a matrix of transformation from a three-dimensional world coordinate to a two-dimensional camera clip coordinate; determine a rotation vector according to the position information of the key point, a standard tiled human face key point array, and the coordinate transformation matrix; and establish a rotation matrix according to the rotation vector, and obtain the first motion state information through the rotation matrix.

Alternatively, the updating module 804 may be configured to: determine a pitch angle change rate, a yaw angle change rate, and a roll angle change rate of the user according to the first motion state information, where the change rate is used for characterizing a rotation angle change per frame; and transfer the pitch angle change rate, the yaw angle change rate, and the roll angle change rate of the user to the moving object to update the second motion state information of the moving object.

The functions of the modules have been described in detail in the method steps in the foregoing embodiments, which will not be redundantly described here.

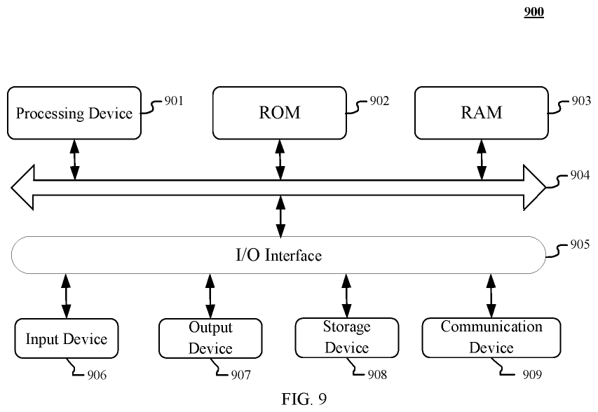

Referring to FIG. 9, FIG. 9 illustrates a schematic structural diagram of an electronic device 900 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like.

As illustrated in FIG. 9, the electronic device 900 may include a processing device 901 (e.g., a central processing unit, a graphics processing unit, etc.), which can perform various suitable actions and processing according to a program stored in a read-only memory (ROM) 902 or a program loaded from a storage device 908 into a random-access memory (RAM) 903. The RAM 903 further stores various programs and data required for operations of the electronic device 900. The processing device 901, the ROM 902, and the RAM 903 are interconnected by means of a bus 904. An input/output (I/O) interface 909 is also connected to the bus 904.

Usually, the following apparatus may be connected to the I/O interface 905: an input device 906 including, for example, a touch screen, a touch pad, a keyboard, a mouse, a camera, a microphone, an accelerometer, a gyroscope, or the like; an output device 907 including, for example, a liquid crystal display (LCD), a loudspeaker, a vibrator, or the like; a storage device 908 including, for example, a magnetic tape, a hard disk, or the like; and a communication device 909. The communication device 909 may allow the electronic device 900 to be in wireless or wired communication with other devices to exchange data. While FIG. 9 illustrates the electronic device 900 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication device 909 and installed, or may be installed from the storage device 908, or may be installed from the ROM 902. When the computer program is executed by the processing device 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them.

In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The present disclosure further provides a processing device 901. The processing device 901 may be a central processing unit, a graphics processing unit, or the like. The processing device 901 may execute a program in a computer-readable medium, e.g., a read only memory 902 to perform the method of the present disclosure.

According to one or more embodiments of the present disclosure, Example 1 provides a method for controlling motion of a moving object. The method includes: obtaining first motion state information, where the first motion state information is motion state information of a user; updating second motion state information of the moving object according to the first motion state information; and controlling the moving object to move according to the second motion state information.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, Example 1 provides a method for controlling motion of a moving object, comprising: obtaining first motion state information, wherein the first motion state information is motion state information of a user; updating second motion state information of the moving object according to the first motion state information; and controlling the moving object to move according to the second motion state information.

According to one or more embodiments of the present disclosure, Example 2 provides the method of Example 1, where the controlling the moving object to move according to the second motion state information includes: controlling a plane where the moving object is located to move according to the second motion state information of the moving object such that the moving object moves relative to the plane where the moving object is located.

According to one or more embodiments of the present disclosure, Example 3 provides the method of Example 2, where the controlling a plane where the moving object is located to move according to the second motion state information of the moving object includes: determining a texture coordinate offset of each pixel in the plane where the moving object is located according to the second motion state information of the moving object; updating texture coordinate of each pixel in the plane where the moving object is located according to the texture coordinate offset of each pixel in the plane where the moving object is located; and rendering a motion effect of the plane where the moving object is located by a shader according to the updated texture coordinate of each pixel in the plane where the moving object is located.

According to one or more embodiments of the present disclosure, Example 4 provides the method of Example 3, where the rendering a motion effect of the plane where the moving object is located by a shader according to the texture coordinate of each pixel in the plane where the moving object is located includes: obtaining a normalized value of the texture coordinate of each pixel in the plane where the moving object is located; determining a color value of each pixel in the plane where the moving object is located according to a correspondence between a texture and a color and the normalized value of the texture coordinate; and rendering a color of each pixel in the plane where the moving object is located by the shader according to the color value to render the motion effect of the plane where the moving object is located.

According to one or more embodiments of the present disclosure, Example 5 provides the method according to any example of Example 1 to Example 4, where the first motion state information includes a pitch angle, a yaw angle, and a roll angle of the user; and the second motion state information includes a pitch angle, a yaw angle, a roll angle, and a moving velocity of the moving object.

According to one or more embodiments of the present disclosure, Example 6 provides the method of Example 5, where the obtaining first motion state information includes: identifying a key point of the user to obtain position information of the key point; and obtaining the first motion state information by matrix transformation according to the position information of the key point and position information of a camera for photographing the user.

According to one or more embodiments of the present disclosure, Example 7 provides the method of Example 6, where the obtaining the first motion state information by matrix transformation according to the position information of the key point and position information of a camera for photographing the user includes: constructing a coordinate transformation matrix according to the position information of the camera, where the coordinate transformation matrix is a matrix of transformation from three-dimensional world coordinate to two-dimensional camera clip coordinate; determining a rotation vector according to the position information of the key point, a standard tiled human face key point array, and the coordinate transformation matrix; and establishing a rotation matrix according to the rotation vector, and obtaining the first motion state information through the rotation matrix.

According to one or more embodiments of the present disclosure, Example 8 provides the method of Example 7, where the updating second motion state information of the moving object according to the first motion state information includes: determining a pitch angle change rate, a yaw angle change rate, and a roll angle change rate of the user according to the first motion state information, where the change rate is used for characterizing a rotation angle change per frame; and transferring the pitch angle change rate, the yaw angle change rate, and the roll angle change rate of the user to the moving object to update the second motion state information of the moving object.

According to one or more embodiments of the present disclosure, Example 9 provides an apparatus for controlling motion of a moving object, including a communication module configured to obtain first motion state information, where the first motion state information is motion state information of a user; an updating module configured to update second motion state information of the moving object according to the first motion state information; and a control module configured to control the moving object to move according to the second motion state information.

According to one or more embodiments of the present disclosure, Example 10 provides the apparatus of Example 9, where the control module may be configured to: control a plane where the moving object is located to move according to the second motion state information of the moving object such that the moving object moves relative to the plane where the moving object is located.

According to one or more embodiments of the present disclosure, Example 11 provides the apparatus of Example 10, where the control module may be configured to: determine a texture coordinate offset of each pixel in the plane where the moving object is located according to the second motion state information of the moving object; update texture coordinate of each pixel in the plane where the moving object is located according to the texture coordinate offset of each pixel in the plane where the moving object is located; and render a motion effect of the plane where the moving object is located by a shader according to the updated texture coordinate of each pixel in the plane where the moving object is located.

According to one or more embodiments of the present disclosure, Example 12 provides the apparatus of Example 11, where the control module may be configured to: obtain a normalized value of the texture coordinate of each pixel in the plane where the moving object is located; determine a color value of each pixel in the plane where the moving object is located according to a correspondence between a texture and a color and the normalized value of the texture coordinate; and render a color of each pixel in the plane where the moving object is located by the shader according to the color value to render the motion effect of the plane where the moving object is located.

According to one or more embodiments of the present disclosure, Example 13 provides the apparatus according to any one of Example 9 to Example 12, the first motion state information includes a pitch angle, a yaw angle, and a roll angle of the user; and the second motion state information includes a pitch angle, a yaw angle, a roll angle, and a moving velocity of the moving object.

According to one or more embodiments of the present disclosure, Example 14 provides the apparatus of Example 3, where the communication module may be configured to: identify a key point of the user to obtain position information of the key point; and obtain the first motion state information by matrix transformation according to the position information of the key point and position information of a camera for photographing the user.

According to one or more embodiments of the present disclosure, Example 15 provides the apparatus of Example 14, where the communication module 802 may be configured to: construct a coordinate transformation matrix according to the position information of the camera, where the coordinate transformation matrix is a matrix of transformation from three-dimensional world coordinate to two-dimensional camera clip coordinate; determine a rotation vector according to the position information of the key point, a standard tiled human face key point array, and the coordinate transformation matrix; and establish a rotation matrix according to the rotation vector, and obtaining the first motion state information through the rotation matrix.

According to one or more embodiments of the present disclosure, Example 16 provides the apparatus of Example 15, where the updating module 804 may be configured to: determine a pitch angle change rate, a yaw angle change rate, and a roll angle change rate of the user according to the first motion state information, where the change rate is used for characterizing a rotation angle change per frame; and transfer the pitch angle change rate, the yaw angle change rate, and the roll angle change rate of the user to the moving object to update the second motion state information of the moving object.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A method for controlling a moving object to move, comprising:
obtaining first motion state information, wherein the first motion state information is motion state information of a user;
updating second motion state information of the moving object according to the first motion state information; and
controlling the moving object to move according to the second motion state information.

2. The method according to claim 1, wherein the controlling the moving object to move according to the second motion state information comprises:
controlling a plane where the moving object is located to move according to the second motion state information of the moving object such that the moving object moves relative to the plane where the moving object is located.

3. The method according to claim 2, wherein the controlling a plane where the moving object is located to move according to the second motion state information of the moving object comprises:
determining a texture coordinate offset of each pixel in the plane where the moving object is located according to the second motion state information of the moving object;
updating a texture coordinate of each pixel in the plane where the moving object is located according to the texture coordinate offset of the each pixel in the plane where the moving object is located; and
rendering a motion effect of the plane where the moving object is located by a shader according to the updated texture coordinate of each pixel in the plane where the moving object is located.

4. The method according to claim 3, wherein the rendering a motion effect of the plane where the moving object is located by a shader according to the texture coordinate of each pixel in the plane where the moving object is located comprises:
obtaining a normalized value of the texture coordinate of each pixel in the plane where the moving object is located;
determining a color value of each pixel in the plane where the moving object is located according to the normalized value of the texture coordinate and a correspondence between a texture and a color; and
rendering a color of each pixel in the plane where the moving object is located by the shader according to the color value to render the motion effect of the plane where the moving object is located.

5. The method according to claim 1, wherein the first motion state information comprises a pitch angle, a yaw angle, and a roll angle of the user; and the second motion state information comprises a pitch angle, a yaw angle, a roll angle, and a moving velocity of the moving object.

6. The method according to claim 5, wherein the obtaining first motion state information comprises:
identifying a key point of the user to obtain position information of the key point; and
obtaining the first motion state information by matrix transformation according to the position information of the key point and position information of a camera for photographing the user.

7. The method according to claim 6, wherein the obtaining the first motion state information by matrix transformation according to the position information of the key point and position information of a camera for photographing the user comprises:
constructing a coordinate transformation matrix according to the position information of the camera, wherein the coordinate transformation matrix is a matrix of transformation from a three-dimensional world coordinate to a two-dimensional camera clip coordinate;
determining a rotation vector according to the position information of the key point, a standard tiled human face key point array, and the coordinate transformation matrix; and
establishing a rotation matrix according to the rotation vector, and obtaining the first motion state information through the rotation matrix.

8. The method according to claim 7, wherein the updating second motion state information of the moving object according to the first motion state information comprises:
determining a change rate of the pitch angle, a change rate of the yaw angle, and a change rate of the roll angle of the user according to the first motion state information, wherein the change rate is used for characterizing a rotation angle change per frame; and
transferring the change rate of the pitch angle, the change rate of the yaw angle, and the change rate of the roll angle of the user to the moving object to update the second motion state information of the moving object.

9. An apparatus for controlling a moving object to move, comprising:
a communication module configured to obtain first motion state information, wherein the first motion state information is motion state information of a user;
an updating module configured to update second motion state information of the moving object according to the first motion state information; and
a control module configured to control the moving object to move according to the second motion state information.

10. An electronic device, comprising:
a storage device in which a computer program is stored; and
a processing device configured to execute the computer program in the storage device to implement a method comprising:
obtaining first motion state information, wherein the first motion state information is motion state information of a user;
updating second motion state information of the moving object according to the first motion state information; and
controlling the moving object to move according to the second motion state information.

11. A computer-readable storage medium in which a computer program is stored, wherein the method according to claim 1 is implemented when the computer program is executed by a processing unit.

12. A computer program product, wherein when the computer program product is run on a computer, the computer is enabled to implement the method according to claim 1.

13. The electronic device according to claim 10, wherein the controlling the moving object to move according to the second motion state information comprises:
controlling a plane where the moving object is located to move according to the second motion state information of the moving object such that the moving object moves relative to the plane where the moving object is located.

14. The electronic device according to claim 13, wherein the controlling a plane where the moving object is located to move according to the second motion state information of the moving object comprises:
determining a texture coordinate offset of each pixel in the plane where the moving object is located according to the second motion state information of the moving object;
updating a texture coordinate of each pixel in the plane where the moving object is located according to the texture coordinate offset of the each pixel in the plane where the moving object is located; and
rendering a motion effect of the plane where the moving object is located by a shader according to the updated texture coordinate of each pixel in the plane where the moving object is located.

15. The electronic device according to claim 14, wherein the rendering a motion effect of the plane where the moving object is located by a shader according to the texture coordinate of each pixel in the plane where the moving object is located comprises:
obtaining a normalized value of the texture coordinate of each pixel in the plane where the moving object is located;
determining a color value of each pixel in the plane where the moving object is located according to the normalized value of the texture coordinate and a correspondence between a texture and a color; and
rendering a color of each pixel in the plane where the moving object is located by the shader according to the color value to render the motion effect of the plane where the moving object is located.

16. The electronic device according to claim 10, wherein the first motion state information comprises a pitch angle, a yaw angle, and a roll angle of the user; and the second motion state information comprises a pitch angle, a yaw angle, a roll angle, and a moving velocity of the moving object.

17. The electronic device according to claim 16, wherein the obtaining first motion state information comprises:
identifying a key point of the user to obtain position information of the key point; and
obtaining the first motion state information by matrix transformation according to the position information of the key point and position information of a camera for photographing the user.

18. The electronic device according to claim 17, wherein the obtaining the first motion state information by matrix transformation according to the position information of the key point and position information of a camera for photographing the user comprises:
constructing a coordinate transformation matrix according to the position information of the camera, wherein the coordinate transformation matrix is a matrix of transformation from a three-dimensional world coordinate to a two-dimensional camera clip coordinate;
determining a rotation vector according to the position information of the key point, a standard tiled human face key point array, and the coordinate transformation matrix; and
establishing a rotation matrix according to the rotation vector, and obtaining the first motion state information through the rotation matrix.

19. The electronic device according to claim 18, wherein the updating second motion state information of the moving object according to the first motion state information comprises:
determining a change rate of the pitch angle, a change rate of the yaw angle, and a change rate of the roll angle of the user according to the first motion state information, wherein the change rate is used for characterizing a rotation angle change per frame; and
transferring the change rate of the pitch angle, the change rate of the yaw angle, and the change rate of the roll angle of the user to the moving object to update the second motion state information of the moving object.

20. The apparatus according to claim 9, wherein the control module is configured to control a plane where the moving object is located to move according to the second motion state information of the moving object such that the moving object moves relative to the plane where the moving object is located.
